(19) United States
(12) Patent Application Publication
(10) Pub. No.: US 2019/0259023 A1
(43) Pub. Date: Aug. 22, 2019

(54) METHOD AND SYSTEM FOR MEASURING ACTIVE USERS ACROSS A NETWORK OF DIGITAL WALLETS

(71) Applicant: MASTERCARD INTERNATIONAL INCORPORATED, Purchase, NY (US)

(72) Inventors: Jason Candee, New York, NY (US); Alan L. Wang, Chesterfield, MO (US); Jesse E. Owens, New York, NY (US)

(73) Assignee: MASTERCARD INTERNATIONAL INCORPORATED, Purchase, NY (US)

(21) Appl. No.: 16/113,281

(22) Filed: Aug. 27, 2018

Related U.S. Application Data
(60) Provisional application No. 62/550,774, filed on Aug. 28, 2017.

(51) Int. Cl. G06Q 20/36; H04L 12/26

(52) U.S. Cl. CPC G06Q 20/36; H04L 43/0876

(57) ABSTRACT

A method for measuring activity across a network of digital wallets utilizing application programming interfaces includes: storing, in a processing server, a plurality of wallet profiles, each profile including data related to an electronic wallet that is not hosted in a computing system including the processing server, the wallet profile including a wallet identifier; receiving a registration message submitted via an application programming interface (API) of the processing server, the message including a new wallet identifier; inserting a new wallet profile that includes the new wallet identifier; receiving transaction notifications via the API, each transaction notification being related to a processed payment transaction and including an associated wallet identifier related to the electronic wallet used to fund the respective processed payment transaction; measuring wallet activity based on a number of unique associated wallet identifiers included in the transaction notifications; and reporting the measured wallet activity.

### FIELD

The present disclosure relates to the measuring of activity across a network of digital wallets, specifically the use of application programming interfaces to register and track activity of a digital wallet that is externally hosted and operated.

### BACKGROUND

As mobile devices and other types of computing devices have increased in their usage for conducting payment transactions, the number of electronic wallet application programs that can be used by these computing devices has increased. For any given device, a consumer may have the choice among a vast number of electronic wallets to use to store their payment credentials for conveyance to a merchant in a payment transaction. Some of these wallets are hosted directly by a payment processor, also referred to herein as a payment network, or a financial institution associated with a transaction account, such as an issuing or acquiring bank, which can streamline the processing of payment transactions involving the wallet. Other wallets are hosted by external computing systems, which may utilize features, technology, and infrastructure of payment networks and other hosting services via application programming interfaces (APIs).

In the case of an external wallet that communicates with a payment network via an API, the payment network may be limited to receiving messages regarding use of external wallets to transaction messages that are received during the process of processing payment transactions. Currently, these messages lack any information directly identifying the wallet that the transaction is associated with. As a result, these services that provide APIs for external wallets are unable to measure the activity of electronic wallets that they do not directly host, which may be viewed as both a business goal and a technological goal that are defeated by a technical problem of the systems not being able to identify the wallets associated with the respective payment cards they are stored in during transactions. Such information may be valuable with respect to upgrading and operating network infrastructure, allocation of network and processing resources, and other functions that can be affected by the volume of activity related to externally-hosted electronic wallets.

Thus, there is a need for a technological solution for measuring the activity of electronic wallets that are hosted in an external computing system.

### SUMMARY

The present disclosure provides a description of systems and methods for measuring activity across a network of digital wallets utilizing application programming interfaces (APIs). APIs are used to communicate with digital wallets that are hosted in an external computing system, to receive messages therefrom regarding registration of the digital wallet and usage thereof in transactions. A unique identifier is assigned to each wallet by its host, which is included in communications made via the API, which can enable the processing server to track all of the activity of the digital wallet even when not hosted by the processing server. In exemplary embodiments, the processing server is designed to store no personally identifiable information about each digital wallet or its owner, or any data that may be suitable for linking digital wallets together, to maintain a high level of account privacy and security, while still enabling the processing server to measure various types of activity involving the digital wallets.

A method for measuring activity across a network of digital wallets utilizing application programming interfaces includes: storing, in a wallet database of a processing server, a plurality of wallet profiles, wherein each wallet profile includes a structured data set related to an electronic wallet that is not hosted in a computing system including the processing server, the wallet profile including at least a wallet identifier; receiving, by a receiving device of the processing server, a registration message submitted via an application programming interface of the processing server, wherein the registration message includes at least a new wallet identifier; executing, by a querying module of the processing server, a query on the wallet database to insert a new wallet profile that includes at least the new wallet identifier; receiving, by the receiving device of the processing server, a plurality of transaction notifications via the application programming interface, wherein each transaction notification is related to a processed payment transaction and includes at least an associated wallet identifier related to the electronic wallet used to fund the respective processed payment transaction; measuring, by an analytical module of the processing server, wallet activity based on a number of unique associated wallet identifiers included in the received plurality of transaction notifications; and reporting, by a reporting module of the processing server, the measured wallet activity.

A system for measuring activity across a network of digital wallets utilizing application programming interfaces includes: an analytical module of a processing server; a reporting module of the processing server; a wallet database of the processing server configured to store a plurality of wallet profiles, wherein each wallet profile includes a structured data set related to an electronic wallet that is not hosted in a computing system including the processing server, the wallet profile including at least a wallet identifier; a receiving device of the processing server configured to receive a registration message submitted via an application programming interface of the processing server, wherein the registration message includes at least a new wallet identifier; and a querying module of the processing server configured to execute a query on the wallet database to insert a new wallet profile that includes at least the new wallet identifier, wherein the receiving device of the processing server is further configured to receive a plurality of transaction notifications via the application programming interface, wherein each transaction notification is related to a processed payment transaction and includes at least an associated wallet identifier related to the electronic wallet used to fund the respective processed payment transaction, the analytical module of the processing server is configured to measure wallet activity based on a number of unique associated wallet identifiers included in the received plurality of transaction notifications, and the reporting module of the processing server is configured to report the measured wallet activity.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for measuring activity across a network of digital wallets in accordance with exemplary embodiments.

FIG. 2 is a block diagram illustrating the processing server of the system of FIG. 1 for the measuring of activity across a network of externally hosted digital wallets in accordance with exemplary embodiments.

FIG. 3 is a flow diagram illustrating a process for the measuring of activity of a network of digital wallets using the system of FIG. 1 in accordance with exemplary embodiments.

FIG. 4 is a flow chart illustrating an exemplary method for measuring activity across a network of digital wallets using application programming interfaces in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Measuring Activity Across a Network of Digital Wallets

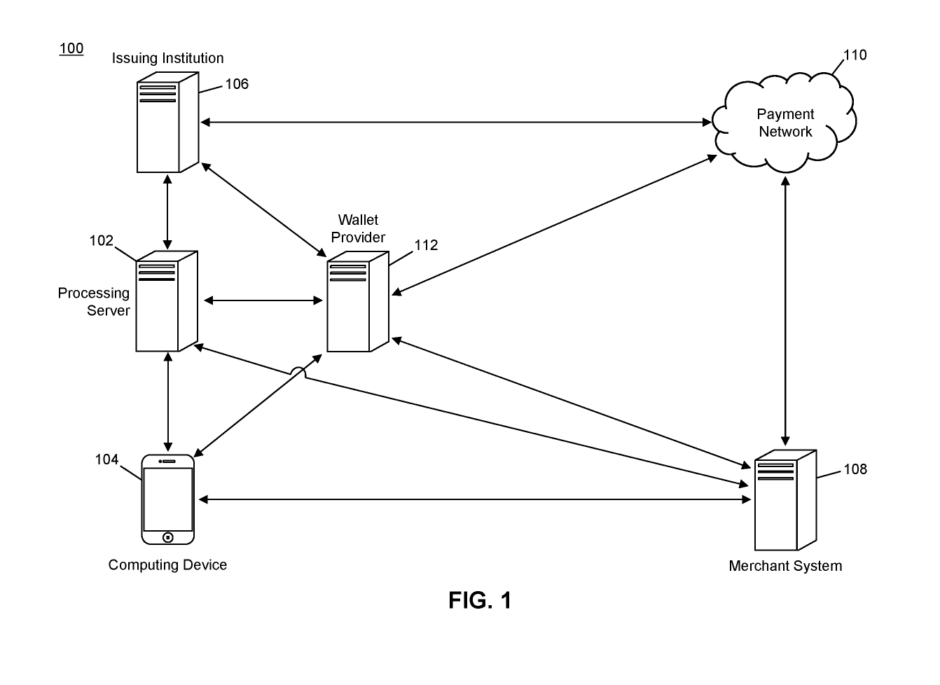

FIG. 1 illustrates a system 100 for the measuring of activity across a network of digital wallets, also referred to herein as electronic wallets, that are externally hosted via the use of application programming interfaces (APIs) while maintaining account and user security.

The system 100 may include a processing server 102. The processing server 102, discussed in more detail below, may be specifically configured to host electronic wallets that may be used by consumers in provisioning payment credentials used to fund electronic payment transactions. As discussed herein, the processing server 102 may also be configured to provide APIs for use by externally hosted electronic wallets, such as may be hosted by a wallet provider 112. The wallet provider 112 may be external to a computing system that involves the processing server 102 and may, in some cases, be owned and/or operated by an external (e.g., legally independent) entity from the processing server 102. The wallet provider 112 may communicate with the processing server 102 via APIs provided thereby, which may provide the wallet provider 112 with access to features and components that may assist the wallet provider 112 in the hosting of an electronic wallet for use by a consumer in funding a payment transaction.

In the system 100, an issuing institution 106 may issue a transaction account for use in funding electronic payment transactions. As part of the issuing of the transaction account, the issuing institution 106 may generate payment credentials associated therewith, which may be presented to a merchant system 108 as part of the initiation of a payment transaction in order to fund the payment transaction with the associated transaction account. In the system 100, a consumer may possess or otherwise have access to a computing device 104, which may be used to store application data associated with an electronic wallet. The electronic wallet may be hosted by the wallet provider 112, which may utilize an API connection to the processing server 102. The computing device 104 may be configured to store the payment credentials issued by the issuing institution 106 in the electronic wallet hosted by the wallet provider 112 or in a secure storage that is accessible thereby. In some embodiments, the wallet provider 112 may be configured to store the payment credentials on behalf of the computing device 104. The computing device 104 may be any type of computing device suitable for performing the functions discussed herein, such as a desktop computer, notebook computer, laptop computer, tablet computer, cellular phone, smart phone, smart watch, smart television, wearable computing device, implantable computing device, etc. In some embodiments, the processing server 102 may be a part of the issuing institution 106.

Prior to use of the electronic wallet hosted by the wallet provider 112, the consumer may, using the computing device 104, register for a new electronic wallet with the wallet provider 112. As part of the registration process, the consumer may provide authentication as to their identity and authorization of use of the transaction account issued by the issuing institution 106. Such information may include, for instance, a username and password combination used to access their transaction account with the issuing institution 106, manual input of payment credentials, submission of transaction data showing proof of access and/or control of the transaction account, etc. As part of the registration process, the wallet provider 112 may assign a unique value to the electronic wallet. The unique value, referred to herein as a wallet identifier, may be a value, such as an alphanumeric value, that is unique to the electronic wallet as used by the wallet provider 112. In some embodiments, the wallet identifier may be unique as to all electronic wallets regardless of host (e.g., the identifier may be unique to all wallets hosted by the processing server 102, the wallet provider 112, and any other wallet host. As part of this registration process, the wallet provider 112 may provide a registration message to the processing server 102 via the API, which may include an indication that a new electronic wallet is registered as well as the unique identifier assigned to that electronic wallet.

The processing server 102 may receive the registration message with the unique identifier, and may store a profile of the electronic wallet in a wallet database, discussed in more detail below. The processing server 102 may continue to receive and store unique identifiers for every externally-hosted electronic wallet that utilizes the processing server 102 via API. The processing server 102 may similarly receive messages from the wallet provider 112 via API any time modification is made to the electronic wallet. For instance, if the consumer uses the computing device 104 to add additional payment credentials to the electronic wallet, freeze the electronic wallet, request deletion of the electronic wallet, etc., the wallet provider 112 may submit a message to the processing server 102 via API that indicates accordingly, where each communication may use the unique identifier. The processing server 102 may use the unique identifier to group together messages by the unique identifier such that the processing server 102 may be able to keep the activity of each electronic wallet separate and attributable thereto.

When the consumer wants to conduct a payment transaction, the consumer may instruct the computing device 104 to electronically transmit the payment credentials stored in the electronic wallet to the merchant system 108 using a suitable communication network and method (e.g., near field communication, Bluetooth, radio frequency, local area network, cellular communication, etc.). For example, an electronic wallet may be implemented to convey payment credentials via an application program executed on the computing device 104 (e.g., an electronic wallet application), through a web page, directly to a terminal of the merchant system 108 (e.g., via near field communication), or through any other type of communication suitable for conveying payment credentials. The merchant system 108 may receive the payment credentials, which may be included in a transaction message that is submitted to a payment network 110 via payment rails associated therewith for processing (e.g., directly by the merchant system 108 or through one or more intermediate entities, such as an acquiring institution, gateway processor, etc.). The transaction message may be a data message formatted pursuant to one or more standards governing the exchange of financial transaction messages, such as the International Organization of Standardization's ISO 8583 or 20022 standards. The payment network 110 may process the payment transaction using traditional methods and systems, which may include forwarding the transaction message to the issuing institution 106, which may decide to approve or deny the payment transaction, and return the result in an authorization response to the payment network 110, which may process the payment transaction accordingly.

As part of the payment transaction, the computing device 104 may convey the wallet identifier associated with the electronic wallet to the merchant system 108 along with the payment credentials. The merchant system 108 may include the wallet identifier in the transaction message that is submitted to the payment network 110 for processing. In one embodiment, the transaction message may include a plurality of data elements, where the wallet identifier may be stored in a data element that is configured for private use in the applicable standard(s). In some embodiments, the transaction message may also include a unique value associated with the wallet provider 112 with whom the electronic wallet is hosted, also referred to herein as an operator identifier. Once the transaction has been processed, the wallet provider 112 may be informed of the processing, either via the computing device 104, from the issuing institution 106, or directly from the payment network 110, depending on implementation of the system 100 and type of payment transaction being processed (e.g., some transactions may seek independent authorization of the wallet provider 112). The wallet provider 112 may receive the confirmation of the payment transaction and may then electronically transmit a notification of the processed transaction to the processing server 102 using a suitable communication network and method. The notification may include at least an indication that a transaction was successfully processed and the unique identifier associated with the electronic wallet. In some embodiments, no additional data may be included in the transaction notification. In other embodiments, the transaction notification may not include any data that may be personally identifiable as to the consumer associated with the transaction account. In some instances, the merchant system 108 may provide a notification to the processing server 102 (e.g., directly using the API or via the wallet provider 112, as illustrated in FIG. 1) for confirmation of the payment transaction.

The processing server 102 may receive the unique identifier and may store the indication of the processed payment transaction in the wallet profile for the electronic wallet. The processing server 102 may then measure activity of electronic wallets that are externally hosted based on the messages received via the APIs that include a wallet identifier associated with externally hosted electronic wallets, which may also include an operator identifier associated with the respective wallet provider 112, as applicable. The processing server 102 may be configured to generate reports, which may include data regarding the frequency of usage of externally hosted electronic wallets, the number and/or rate of registration or other account modification of externally hosted electronic wallets, or other reporting data that may be generated based on the data received by the processing server 102 as indicated herein. In some embodiments, the processing server 102 may be configured to provide generated reports to outside entities. For instance, the processing server 102 may provide reports regarding the amount of activity by electronic wallets hosted directly by the processing server 102 as well as one or more wallet providers 112 to issuing institutions 106, payment networks 110, acquiring institutions, or other entities. In some cases, each report may not include the unique identifiers associated with electronic wallets considered in the reports.

In some embodiments, the processing server 102 may be configured to prevent the accumulation of data in wallet profiles that may be considered personally identifiable. For instance, as activity is measured for each electronic wallet, the processing server 102 may prevent the storage of or discard any additional information regarding the measured activity beyond the unique identifier and an indication that the activity was performed. For instance, for a payment transaction the processing server 102 may not store the account number or other payment credentials included in the transaction message. In some cases, any additional transaction data included in the transaction message that may be used to connect the electronic wallet to a transaction account may be discarded, such as the transaction amount and transaction time (e.g., but where the transaction date may be retained for activity measuring). In these embodiments, the processing server 102 may also discard any data that may be used to link electronic wallets, as the linking of one electronic wallet to another may be potentially personally identifiable. In such embodiments, the processing server 102 may be configured to delete or otherwise obscure data upon receipt and to remove stored data as necessary. For instance, transaction data may be retained until activity is measured, at which time it may be discarded.

The methods and systems discussed herein provide for the measuring of activity of a network of electronic wallets through the use of APIs provided by the processing server 102 for wallets hosted externally by wallet providers 112. The APIs may provide for the ability of wallet providers 112 to take advantage of features offered by the processing server 102, while at the same time enabling the wallet provider 112 to host electronic wallets directly, which may free the processing server 102 of some data storage and processing costs. The use of a unique identifier for each electronic wallet may ensure that the processing server 102 is able to keep each electronic wallet independent and accounted for, to provide for more accurate measuring, and without the need to link any electronic wallet, to achieve high account and consumer security. By enabling wallet providers 112 to generate and use their own unique identifiers, which are communicated via the APIs, the processing server 102 may provide for this activity measuring with minimal modification to wallet provider systems. As a result, the processing server 102 may be configured to accurately and efficiently measure activity of a network of digital wallets that is externally hosted with minimal effect on external resources and while maintaining a high level of consumer and account security.

### Processing Server

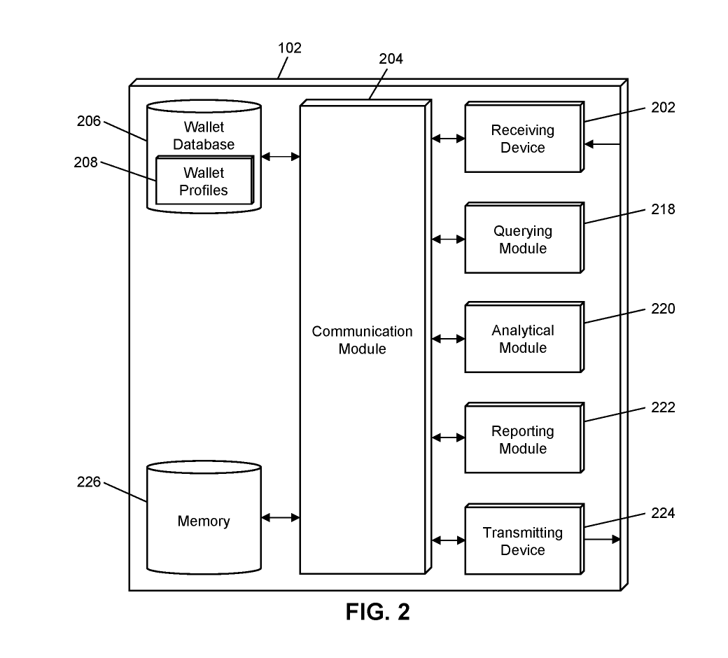

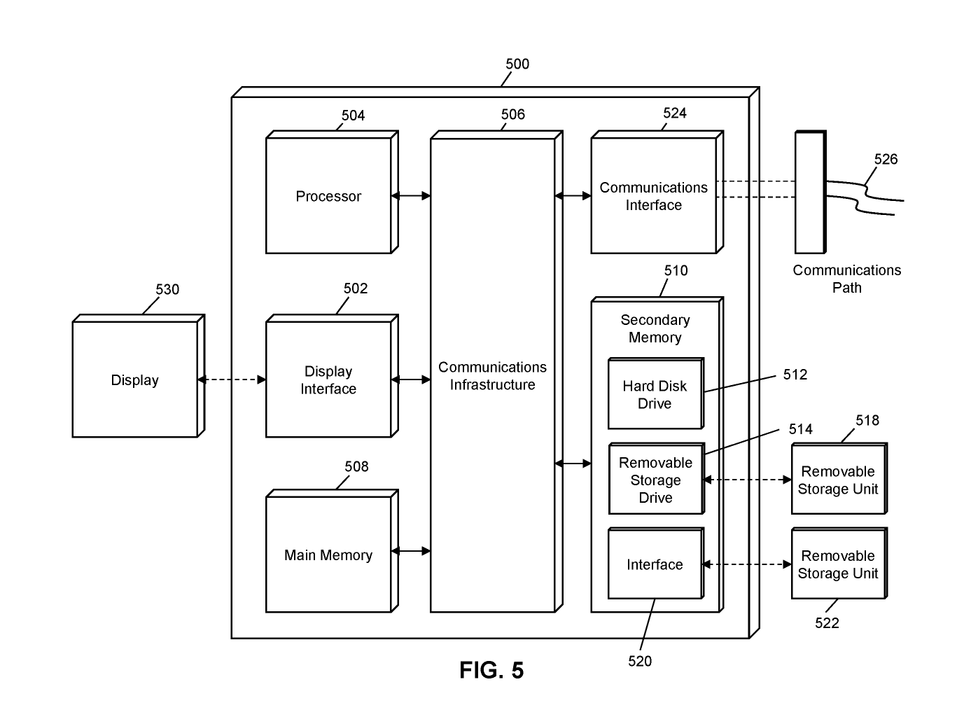

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from computing devices 104, issuing institutions 106, wallet providers 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by wallet providers 112, which may be superimposed or otherwise encoded with data signals that are received via an API and include at least notifications regarding transactions and/or account management and a wallet identifier associated with the electronic wallet to which the notification is associated. In cases where the processing server 102 hosts electronic wallets directly, the receiving device 202 may be configured to receive data signals electronically transmitted by computing devices 104, which may be superimposed or otherwise encoded with transaction account credentials and authentication data used for registration of electronic wallets, and electronically transmitted by issuing institutions 106, which may be superimposed or otherwise encoded with payment credentials and other data for use in the electronic wallet.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, analytical module 220, reporting module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include a wallet database 206. The wallet database 206 may be configured to store a plurality of wallet profiles 208 using a suitable data storage format and schema. The wallet database 206 may be a relational database that utilizes structured query language for the storage, identification, modifying, updating, accessing, etc. of structured data sets stored therein. Each wallet profile 208 may be a structured data set configured to store data related to an electronic wallet, including electronic wallets hosted by external wallet providers 112 for which data is received via APIs operated by the processing server 102. Each wallet profile 208 may include at least a wallet identifier assigned to the electronic wallet by the associated wallet provider 112. In some cases, the wallet profile 208 may further include data regarding usage and/or activity of the related electronic wallet. In an exemplary embodiment, each wallet profile 208 may not include any personally identifiable information or information linking one wallet profile 208 to another wallet profile 208 or to any other electronic wallet.

The processing server 102 may include a querying module 218. The querying module 218 may be configured to execute queries on databases to identify information. The querying module 218 may receive one or more data values or query strings, and may execute a query string based thereon on an indicated database, such as the wallet database 206, to identify information stored therein. The querying module 218 may then output the identified information to an appropriate engine or module of the processing server 102 as necessary. The querying module 218 may, for example, execute a query on the wallet database 206 to insert a new wallet profile 208 upon the receipt (e.g., by the receiving device 202) of a message indication that a new electronic wallet was registered by a wallet provider 112, where the new wallet profile 208 may include the wallet identifier assigned to the new electronic wallet by the wallet provider 112.

The processing server 102 may also include an analytical module 220. The analytical module 220 may be configured to analyze data received by the processing server 102 and stored therein to perform the functions of the processing server 102 as discussed herein. The analytical module 220 may receive data as input, may perform analysis of the data, and may output a result of the analysis to another module or engine of the processing server 102. The analytical module 220 may, for example, be configured to measure activity of one or more external electronic wallets hosted by one or more wallet providers 112. Such activity may include general activity or may be specific as to a type of activity (e.g., registration, deletion, modification, transactions, etc.). In some cases, activity may be measured for a specific type of electronic wallet (e.g., all wallets of a wallet provider 112), electronic wallets for a wallet of network providers 112, or all electronic wallets operated via API connections to the processing server 102.

The processing server 102 may also include a reporting module 222. The reporting module 222 may be configured to generate reports based on data identified by the processing server 102 for performing the functions discussed herein. The reporting module 222 may receive data as input, may generate a report based on that data, and may output the report to another module or engine of the processing server 102. The reporting module 222 may be configured to, for instance, generate a report based on measured activity of electronic wallets, such as measured by the analytical module 220. The report may include the output of the analytical module 220, which may be formatted or filtered or otherwise modified based on reporting requirements or requests. For instance, an issuing institution 106 or other entity may request a report of electronic wallet activity and may request the report include specific data or be formatted in a specific way, which may be followed by the reporting module 222 in generating the report.

The processing server 102 may also include a transmitting device 224. The transmitting device 224 may be configured to transmit data over one or more networks via one or more network protocols. In some instances, the transmitting device 224 may be configured to transmit data to computing devices 104, issuing institutions 106, wallet providers 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to wallet providers 112, which may be superimposed or otherwise encoded with data requests for wallet identifiers or other data associated with electronic wallets. In embodiments where the processing server 102 may be configured to host electronic wallets, the transmitting device 224 may be configured to electronically transmit data signals to computing devices 104 and issuing institutions 106, such as may be superimposed or otherwise encoded with payment credentials or requests for payment credentials, for instance.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, formatting rules for reports, rules for the obscuring or removal of potentially personally identifiable information, etc.

### Process for Measuring Activity Across a Network of Electronic Wallets

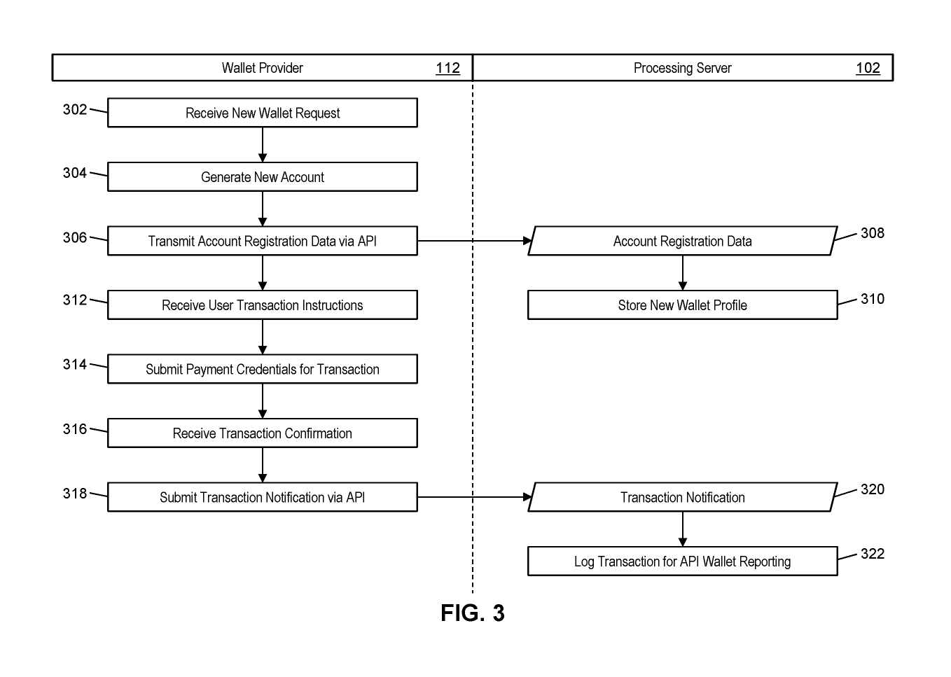

FIG. 3 illustrates an example process executed in the system 100 of FIG. 1 for the measuring of electronic wallet activity across a network of electronic wallets that are hosted externally from the processing server 102 in FIG. 1.

In step 302, the wallet provider 112 may receive a request for a new electronic wallet from a computing device 104, which may submit the request through a suitable communication network and method, such as via an application program associated with the wallet provider 112 that is executed on the computing device 104. The request may include, for instance, authentication data used to prove the user of the computing device's right to use a specific transaction account. In step 304, the wallet provider 112 may authenticate the authentication data and, if successful, may register the computing device 104 for a new electronic wallet. As part of the registration, the wallet provider 112 may generate or otherwise identify a wallet identifier that is uniquely associated with the new electronic wallet. In step 306, the wallet provider 112 may submit at least the wallet identifier and an indication of the new registration to the processing server 102 via an API associated therewith.

In step 308, the receiving device 202 of the processing server 102 may receive the new wallet registration data. In step 310, the querying module 218 of the processing server 102 may execute a query on the wallet database 206 to insert a new wallet profile 208 therein that includes at least the wallet identifier associated with the new electronic wallet.

In step 312, the wallet provider 112 may receive instructions from the computing device 104 that indicates a request to fund a payment transaction, where the request may indicate a transaction account registered with the electronic wallet that is to be used to fund the payment transaction. In step 314, the wallet provider 104 may identify payment credentials associated with the transaction account indicated in the request, and may submit the payment credentials for the transaction. In some cases, the payment credentials may be transmitted to the computing device 104 for forwarding to the merchant system 108. In other cases, the payment credentials may be directly transmitted to the merchant system 108 or a payment network 110 for use in the processing of the payment transaction.

In step 316, the wallet provider 112 may receive a confirmation that the payment transaction was successfully processed. In step 318, the wallet provider 112 may electronically transmit a notification of a successfully processed transaction for the electronic wallet to the processing server 102 via an API associated therewith. In step 320, the receiving device 202 of the processing server 102 may receive the notification via the API, where the notification includes at least the wallet identifier associated with the electronic wallet. In step 322, the querying module 218 may execute a query on the wallet database 206 to update the wallet profile 208 that includes the wallet identifier to store the notification and any transaction data included therein for future use in measuring wallet activity and reporting.

### Exemplary Method for Measuring Electronic Wallet Activity

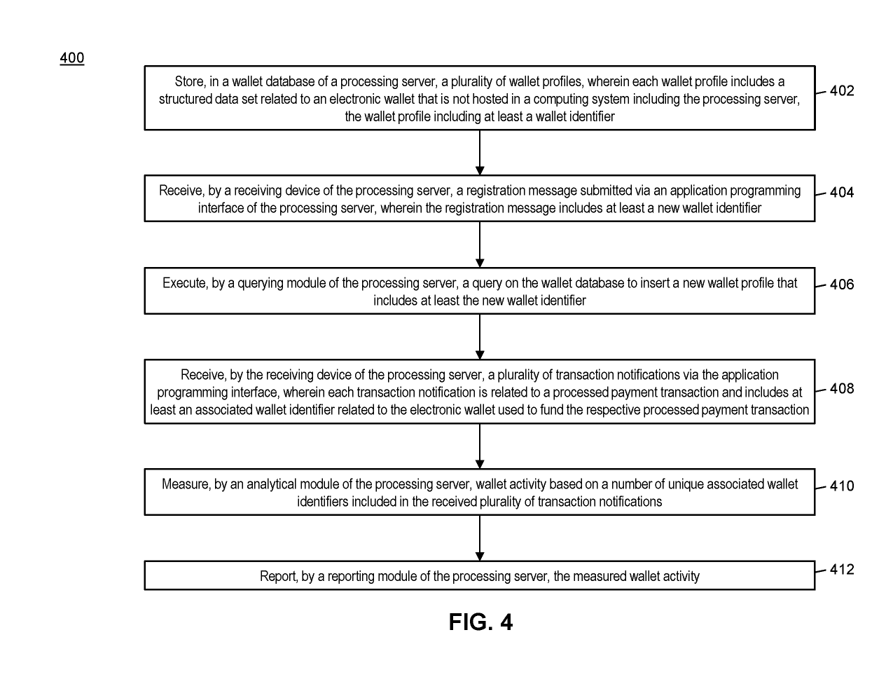

FIG. 4 illustrates a method 400 for the measuring of activity across a network of externally hosted electronic wallets utilizing application programming interfaces (APIs).

In step 402, a plurality of wallet profiles (e.g., wallet profiles 208) may be stored in a wallet database (e.g., the wallet database 206) of a processing server (e.g., the processing server 102), wherein each wallet profile includes a structured data set related to an electronic wallet that is not hosted in a computing system including the processing server, the wallet profile including at least a wallet identifier. In step 404, a registration message submitted via an API of the processing server may be received by a receiving device (e.g., the receiving device 202) of the processing server, wherein the registration message includes at least a new wallet identifier.

In step 406, a query may be executed on the wallet database by a querying module (e.g., the querying module 218) of the processing server to insert a new wallet profile that includes at least the new wallet identifier. In step 408, a plurality of transaction notifications may be received by the receiving device of the processing server via the application programming interface, wherein each transaction notification is related to a processed payment transaction and includes at least an associated wallet identifier related to the electronic wallet used to fund the respective processed payment transaction.

In step 410, wallet activity may be measured by an analytical module (e.g., the analytical module 220) of the processing server based on a number of unique associated wallet identifiers included in the received plurality of transaction notifications. In step 412, the measured wallet activity may be reported by a reporting module (e.g., the reporting module 222) of the processing server.

In one embodiment, the associated wallet identifier included in at least one of the plurality of transaction notifications may be the new wallet identifier. In some embodiments, reporting the measured wallet activity may include electronically transmitting, by a transmitting device (e.g., the transmitting device 224) of the processing server, the measured wallet activity to an external computing system. In one embodiment, the wallet identifier included in each of the plurality of wallet profiles may be unique to the related electronic wallet.

In some embodiments, no two wallet profiles of the plurality of wallet profiles may include a common wallet identifier. In one embodiment, each of the plurality of wallet profiles may further include one operator identifier of a plurality of operator identifiers associated with an entity operating the related electronic wallet. In a further embodiment, the registration message may further include one of the plurality of operator identifiers.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for measuring activity across a network of digital wallets utilizing application programming interfaces. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for measuring activity across a network of digital wallets utilizing application programming interfaces, comprising:
storing, in a wallet database of a processing server, a plurality of wallet profiles, wherein each wallet profile includes a structured data set related to an electronic wallet that is not hosted in a computing system including the processing server, the wallet profile including at least a wallet identifier;
receiving, by a receiving device of the processing server, a registration message submitted via an application programming interface of the processing server, wherein the registration message includes at least a new wallet identifier;
executing, by a querying module of the processing server, a query on the wallet database to insert a new wallet profile that includes at least the new wallet identifier;
receiving, by the receiving device of the processing server, a plurality of transaction notifications via the application programming interface, wherein each transaction notification is related to a processed payment transaction and includes at least an associated wallet identifier related to the electronic wallet used to fund the respective processed payment transaction;
measuring, by an analytical module of the processing server, wallet activity based on a number of unique associated wallet identifiers included in the received plurality of transaction notifications; and
reporting, by a reporting module of the processing server, the measured wallet activity.

2. The method of claim 1, wherein the associated wallet identifier included in at least one of the plurality of transaction notifications is the new wallet identifier.

3. The method of claim 1, wherein reporting the measured wallet activity includes electronically transmitting, by a transmitting device of the processing server, the measured wallet activity to an external computing system.

4. The method of claim 1, wherein the wallet identifier included in each of the plurality of wallet profiles is unique to the related electronic wallet.

5. The method of claim 1, wherein no two wallet profiles of the plurality of wallet profiles includes a common wallet identifier.

6. The method of claim 1, wherein each of the plurality of wallet profiles further includes one operator identifier of a plurality of operator identifiers associated with an entity operating the related electronic wallet.

7. The method of claim 6, wherein the registration message further includes one of the plurality of operator identifiers.

8. The method of claim 1, wherein each wallet profile does not include any personally identifiable information.

9. A system for measuring activity across a network of digital wallets utilizing application programming interfaces, comprising:
an analytical module of a processing server;
a reporting module of the processing server;
a wallet database of the processing server configured to store a plurality of wallet profiles, wherein each wallet profile includes a structured data set related to an electronic wallet that is not hosted in a computing system including the processing server, the wallet profile including at least a wallet identifier;
a receiving device of the processing server configured to receive a registration message submitted via an application programming interface of the processing server, wherein the registration message includes at least a new wallet identifier; and
a querying module of the processing server configured to execute a query on the wallet database to insert a new wallet profile that includes at least the new wallet identifier, wherein
the receiving device of the processing server is further configured to receive a plurality of transaction notifications via the application programming interface, wherein each transaction notification is related to a processed payment transaction and includes at least an associated wallet identifier related to the electronic wallet used to fund the respective processed payment transaction,
the analytical module of the processing server is configured to measure wallet activity based on a number of unique associated wallet identifiers included in the received plurality of transaction notifications, and
the reporting module of the processing server is configured to report the measured wallet activity.

10. The system of claim 9, wherein the associated wallet identifier included in at least one of the plurality of transaction notifications is the new wallet identifier.

11. The system of claim 9, wherein reporting the measured wallet activity includes electronically transmitting, by a transmitting device of the processing server, the measured wallet activity to an external computing system.

12. The system of claim 9, wherein the wallet identifier included in each of the plurality of wallet profiles is unique to the related electronic wallet.

13. The system of claim 9 wherein no two wallet profiles of the plurality of wallet profiles includes a common wallet identifier.

14. The system of claim 9, wherein each of the plurality of wallet profiles further includes one operator identifier of a plurality of operator identifiers associated with an entity operating the related electronic wallet.

15. The system of claim 14, wherein the registration message further includes one of the plurality of operator identifiers.

16. The system of claim 9, wherein each wallet profile does not include any personally identifiable information.
